(19) United States
(12) Patent Application Publication
(10) Pub. No.: US 2009/0006141 A1
(43) Pub. Date: Jan. 1, 2009

(54) Method of Reducing Insurance Costs

(76) Inventor: Nancy Karr, Lindenhurst, IL (US)

Correspondence Address: Husch Blackwell Sanders, LLP;Welsh & Katz, 120 S RIVERSIDE PLAZA, 22ND FLOOR, CHICAGO, IL, 60606, US

(21) Appl. No.: 12/142,561

(22) Filed: Jun. 19, 2008

Related U.S. Application Data
(60) Provisional application No. 60/946,626, filed on Jun. 27, 2007.

(51) Int. Cl. G06Q 40/00

(52) U.S. Cl. 705/4

(57) ABSTRACT

A computerized method and apparatus are provided for reducing insurance costs for a drug to an insurer. The method includes the steps of determining a price of the drug from a plurality of pharmacies, the consumer purchasing the drug from a selected pharmacy with a lower relative price of the plurality of pharmacies and the consumer paying a co-pay based upon a pre-determined percentage of the price of the drug.

This is a continuation-in-part if U.S. Patent Application Ser. No. 60/946,626 filed on Jun. 27, 2007 (pending).

### FIELD OF THE INVENTION

The field of the invention relates to insurance claims and more particularly to methods of reducing insurance costs.

### BACKGROUND OF THE INVENTION

Medical insurance carriers operate to ameliorate risk to the individual. In exchange for insurance premiums, insurance carriers agree to accept and pay reasonable health insurance costs. Whether the premium is paid by the covered individual or an employer, the insurance carrier makes a profit so long as the losses of covered individuals is less than the aggregate of the premiums charged to all individuals.

In order to reduce costs and to discourage unnecessary expenses, most carriers require a co-pay, especially with regard to drug claims. Typically, the co-pay is a fixed dollar value (e.g., $10, $20, etc.). However, even the use of the co-pay is based upon conditions. For example, there may be different co-payment amounts for generic, formulary brand name, and non-formulary brand name drugs. Depending on the medication, there may or may not be an equivalent drug in the lower co-payment categories.

Re-imbursement of outpatient pharmacy expenses by insurers to beneficiaries is based on contractual agreements rooted in such things as historic factors, including available technology, and historic cost structures, including an overlay of partial fixes directed to reducing rising costs. Historical factors may include a history of payment for drugs or treatments or for a certain class of treatments or drugs. Other classes of treatments or drugs may not be covered because the available technology has not developed sufficiently to establish the usefulness of such drugs. Historical cost structures may involve agreements between carriers and drug makers that do not allow for price changes. The overlay of partial fixes may include the default use of generic drugs when available or a requirement that a user accept a long term supply of drugs by mail.

In general, there are few incentives for beneficiaries to reduce an insurance carrier's costs. Often beneficiaries may purchase drugs where convenient rather than where cheapest simply because the co-pay is the same. Accordingly, a need exists for better means for administering insurance plans.

### SUMMARY

A computerized method and apparatus are provided for reducing insurance costs for a drug to an insurer. The method includes the steps of determining a price of the drug from a plurality of pharmacies, the consumer purchasing the drug from a selected pharmacy with a lower relative price of the plurality of pharmacies and the consumer paying a co-pay based upon a pre-determined percentage of the price of the drug.

### BRIEF DESCRIPTION OF THE DRAWINGS

FIG. 1 is a block diagram of a system for providing drugs in accordance with an illustrated embodiment of the invention.

### DETAILED DESCRIPTION OF AN ILLUSTRATED EMBODIMENT

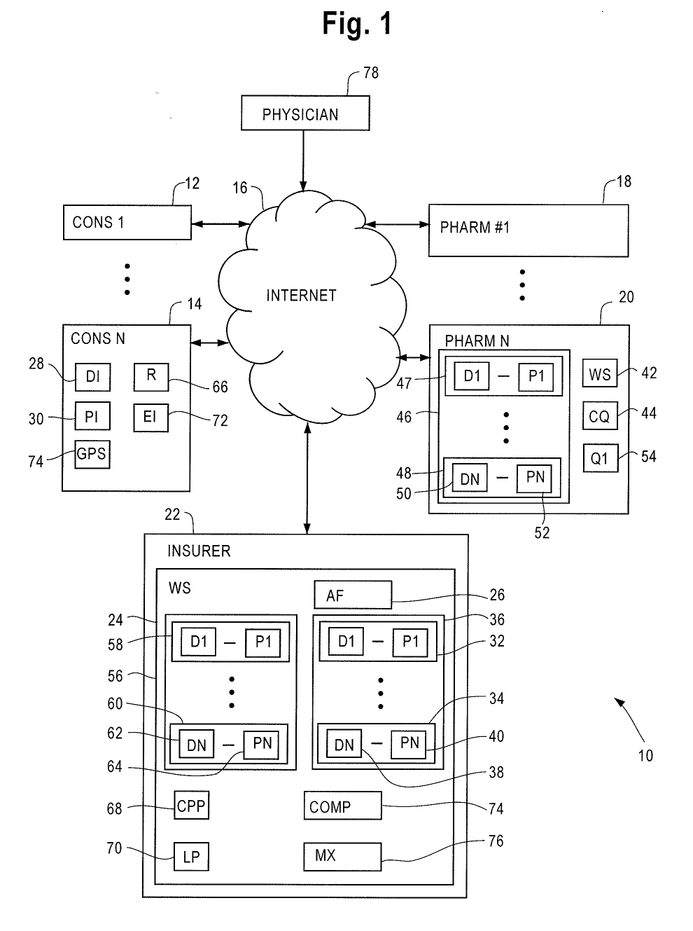

FIG. 1 is a block diagram of a drug payment system 10 shown generally in accordance with an illustrated embodiment of the invention. The system 10 may be used by any of a number of different insurance organizations (including self-insured organizations) to reduce the cost of drugs.

Under the illustrated embodiment, insured consumers 12, 14 may purchase drugs from any of a number of different pharmaceutical sources 18, 20 at the sole discretion of the consumer 12, 14. However, any savings in the purchase of those drugs are shared by both the insurer 22 and consumer 12, 14.

The system 10 allows an insurer to implement a co-pay system in the form of a percentage of total cost to give the beneficiary an incentive to choose a lower cost retail pharmacy. The savings are shared proportionately with the insurer and employer in the case of employer-provided group insurance.

The system 10 motivates cost-sensitive beneficiaries 12, 14 to reduce pharmaceutical costs in at least two ways. First, the system 10 encourages the choice of a lower cost drug provider 18, 20. Second, the system 10 induces price competition among pharmacies 18, 20.

A significant savings may result from the use of the system 10 with no reduction in quality or quantity of medication. In addition, no legislation is needed to allow use of the system 10. In general, the system 10 operates under a set of simple concepts as described in the following paragraphs.

Initially, the co-pay percentage of a beneficiary 12, 14 is based upon some aggregate percentage of pharmaceutical expenses of a group born by the insured collectively over some time period as a fraction of the total pharmaceutical expense for the group. The numerator of this co-pay percentage refers only to the insurance plan segment where the beneficiary chooses a retail pharmacy and the denominator is the total pharmaceutical expense for this segment. This may reflect discounts negotiated with providers by the insurer. Minimum threshold expense for re-imbursement is set at the then-current generic co-pay or other convenient figure to keep claims nontrivial.

A maximum co-payment may be used as a circuit breaker to cap the insured's out-of-pocket payment for unusually expensive items. This could be handled by existing Health Care Accounts (HCA) provided by the employer or maximum out-of-pocket provisions set at some predetermined limit. Alternatively, it could be set at a dollar amount reflecting either a cutoff value determined from the top 5% of the most expensive prescription items or at some top dollar figure deemed affordable by the large majority of beneficiaries.

No distinction is made between generic and brand-name drugs. This is the case because the incentive is reflected in the percentage re-imbursement.

Some patients may see a significant shift in the amount of their co-pay. However, in the aggregate, the group's re-imbursement is initially unchanged and may trend lower as total costs change.

In general, the organization providing the drug insurance plan may provide a website 24 within a host 22 that may be accessed by insurance beneficiaries (consumers) 12, 14 for drug pricing information. Upon accessing the website 24, the consumer 12, 14 may enter an employee identifier 72 and/or an identifier of the insurance plan 30 and a prescription drug identifier 28 and quantity. The drug identifier may be a technical name of the drug or a trade name and may include a dosage strength, drug form (e.g., tablet, liquid, etc.) and route of administration (e.g., oral, suppository, topical, etc.).

Present within the host 22 may also be a search processor 26 that accepts the drug identifier 28 and provides pricing information to the consumer 12, 14 about the drug. As a first step in the process, the search processor 26 may determine if the drug identifier 28 can be validated as a known prescription drug. In order to do this, the search processor 26 may search a database 36 of known drugs. The database 36 may include a file 32, 34 for each known drug. Within the file 32, 34 may be a list of known drug identifiers 38 and an identifier of one or more suppliers 40 of that drug. Also included within the file 32, 34 may be identifiers of generic equivalents.

If the search processor 26 finds a match between the drug identifier 28 provided by the consumer 12, 14, then the search processor 26 may return pricing information for the drug associated with the identifier 28 (and/or generic equivalents) to the consumer 12, 14. If not, then the search processor 26 may return an error message to the consumer 12, 14. By returning pricing information, the consumer 12, 14 is provided with a powerful incentive to reduce the consumer's cost as well as the cost of the insuring organization.

In order to provide pricing information, the search processor 26 may search a database 56 for recent pricing information concerning the prescription. Included within the database 56 may be one or more files 58, 60 associated with each drug. Included within the files 58, 60 may be the drug identifier 62 as well as a price 64 for the drug.

The search processor 26 may also seek more current pricing information about the drug. In this regard, the search processor 26 may retrieve an identifier 40 of a supplier of the drug. The identifier 40 may be a URL of a website 42 of the supplier 18, 20.

Upon retrieving the identifier 40, the search processor may compose and send a cost query 44 to one or more suppliers 18, 20. The cost query 44 may include an identifier of the requesting organization, the identifier 28 of the drug and a request for a quotation for supplying the drug.

A corresponding search processor within a host of the supplier 18, 20 may search a set of files 47, 48 within a drug database 46 for the drug. Within the files 47, 48 may be an identifier 50 of the drug along with a price 52 for that organization. The price 52 may be a then-current retail price for the drug or a discounted price previously negotiated with the organization.

Upon identifying the file 47, 48 associated with the drug, the supplier 40 may compose and send a price quotation 54 to the host 22 of the organization. Upon receiving the price quotation, the search engine 26 may save the contents of the quotation 52 in the local cost database 56.

The search processor 26 may also send the pricing information to a co-pay processor 68. The co-pay processor 68 calculates a co-payment that will be required from the consumer 12, 14 for purchase of the drug or its generic equivalent.

The co-pay calculated by the co-pay processor 68 may be transferred to a comparator 74. Within the comparator 74, the calculated co-pays may be compared with a set of co-pay limits 76. The co-pay limits 76 may be a maximum dollar value for a drug purchase or may include drug identifiers with a maximum co-pay dollar value associated with the drug. When ever a co-pay limit is identified, the comparator 74 transfers the co-pay limit to the co-pay processor 68 where the co-pay limit preempts any co-pay calculated by the co-pay processor.

In addition to determining pricing information, the website 24 may also place the pricing information in order based upon geographic proximity to the consumer 12, 14. In this regard, a location processor 70 associated with the website 24 may determine a geographic location of the consumer 12, 14 and order the pricing information accordingly. For example, if the consumer 12, 14 enters an employee identifier 72, then the location processor 70 may retrieve a home address of the consumer 12, 14 and order the price quotations based upon distance of suppliers from the home of the consumer 12, 14 with the closest pharmacy listed first.

Alternatively, if the consumer 12, 14 is using a cell phone or PDA to access the website 24, then the location processor 70 may access a GPS unit 74 within the cellphone or PDA to determine a current geographical location of the consumer 12, 14. Using the current location of the consumer 12, 14, the location processor 70 may order the price quotations based upon distance from the then-current location of the consumer 12, 14 or, alternatively, may present only drug quotations where the supplier is within a predetermined distance from the consumer.

In response to a query from a consumer 12, 14, the search processor 26 may compose and send a response 66 to the consumer 12, 14 including one or more price quotations for the drug. The response 66 may include a quotation entry for the drug as prescribed as well as additional entries for generic equivalents. In addition to the price for the drug, the response 66 may include an identifier and address of the supplier (pharmacy) 18, 20 offering the price. The consumer 12, 14 may then select and obtain the drug from one of the suppliers 18, 20.

The consumer 12, 14 may review the prices for the drug and the co-pay. While the consumer 12, 14 may opt to pay a higher co-pay in the case of a pharmacy close by, it is more likely that the consumer 12, 14 will choose the pharmacy with the lowest co-pay. In effect, the response 66 sent to the consumer 12, 14 provides the consumer with a means for selecting the pharmacy with the lowest co-pay.

Once the consumer 12, 14 has selected a pharmacy, the consumer 12, 14 may complete the transaction. The consumer 12, 14 may complete the transaction on-line and then pick up the drug in person to satisfy any legal requirements for identification. Alternatively, the consumer 12, 14 may select a pharmacy on-line and then go to the pharmacy and complete the transaction at the time of pick up.

In either case, the co-pay processor 68 may send a summary of the transaction to the pharmacy 18, 20. The summary may include an identifier of the consumer 12, 14 as well as the co-pay required from the consumer. The pharmacy 18, 20 may match the prescription with the summary at pick-up and receive payment of the proper co-pay in conformance with the summary.

Alternatively, the consumer 12, 14 may present a drug insurance card to the pharmacy. In response, a co-payment processor located within a host of the pharmacy may calculate a co-payment as discussed above. If the co-payment processor cannot determine a co-payment either because the pharmacy is not recognized by the organization or it is not clear if the drug is covered, then the pharmacy may require full payment for the drug. In this case, the organization may provide a later rebate of the drug price minus the co-pay to the consumer 12, 14.

In other embodiments, the consumer 12, 14 may use the system 10 without the need for a computer. In this case, the consumer 12, 14 may provide or select the pharmacy 18, 20. The consumer 12, 14 may telephone individual pharmacies 18, 20 for price quotes. Alternatively, the consumer 12, 14 may simply choose a local pharmacy 18, 20 that the consumer 12, 14 knows from previous experience to be lower priced, in general. In this case, no search effort is required and ongoing relationships are preserved. The entire process encourages transparency of pricing by pharmacies 18, 20 since comparison shoppers would select a pharmacy 18, 20 that provides price information on request.

In this case, the consumer 12, 14 may simply notify the physician 78 of the identity of the chosen pharmacy 18, 20 and the physician 78 may send an electronic prescription to the pharmacy 18, 20 designated by the consumer 12, 14. This has the advantage that the consumer 12, 14 doesn't need to decipher the medical abbreviations and handwriting.

As consumers 12, 14 choose lower cost pharmacies, the savings are split automatically between the consumer and the insurer based on the percentage each pays. For example, using some arbitrary numbers for illustration of a single prescription a first pharmacy A may change $84 for a drug while a second pharmacy B may change $72 for the drug resulting in a saving of $12 if the consumer should choose the second pharmacy over the first pharmacy.

If the insured has a 17% co-pay, then the co-pay at Pharmacy A is $14.28 and $12.24 at Pharmacy B, saving the insured $2.04 by choosing Pharmacy B. The insurer saves the other 83% of the total $12 savings ($9.96).

Not every customer is cost-sensitive in every instance, but most people are cost-sensitive most of the time. Customers using cents-off grocery coupons would be even more sensitive to the larger savings in the pharmacy department. Urgent and after-hours needs would continue to be met at 24 hour pharmacies without regard to cost.

In general, many thousands of cost-sensitive shoppers each saving themselves and their insurer a few dollars per prescription add up to huge savings. In subsequent years, the savings can be calculated as an experience rating for the employer. The experience rating may be used to reduce costs to the employer as well as to reset the percentage co-pay of consumers 12, 14 to a lower number.

It may be desirable to discount the cost for a first year to employers as an incentive to use the system 10. The discount may be based on the prospective savings. Alternatively, the savings may be refunded to the employer after the first year, with an overall profit built into subsequent years' pricing. Setting the co-pay percentage by group addresses any regional variations in price as well as overall utilization by the group. Annual experience-related adjustments to the percentage co-pay and the employers' cost may also be made.

In summary, the system 10 empowers the consumer to exercise control over pharmaceutical expenses while the employer and insurer reap some of the benefits. In general, insurers can no longer afford to allow the consumer to be unaware of the financial consequences of his/her choices of pharmacy.

In another embodiment, the savings achieved is evaluated by comparing actual expenses under the percentage co-payment plan to a baseline under the previous plan for the same year. The baseline for cost comparison is the projected pharmaceutical expense under the previous fixed co-pay plan, which reflects rising costs and possibly an increase in the number of beneficiaries. The comparison is only for the market segment where the beneficiary chooses a retail pharmacy, typically providing up to a 30 day supply of medication. This allows a better comparison of the 2 plans without the effects of the total pharmaceutical plan.

A specific embodiment of method and apparatus for reducing insurance costs has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A computerized method of reducing insurance costs for a drug to an insurer and a consumer comprising:
determining a price of the drug from a plurality of pharmacies;
the consumer purchasing the drug from a selected pharmacy with a lower relative price of the plurality of pharmacies; and
the consumer paying a co-pay based upon a pre-determined percentage of the price of the drug.

2. The computerized method of reducing insurance costs as in claim 1 further comprising determining the predetermined percentage by dividing a total drug cost for an insurance plan segment covering the drug by total pharmaceutical expenses for the plan segment.

3. The computerized method of reducing insurance costs as in claim 2 further comprising limiting the co-pay to a predetermined maximum dollar value.

4. The computerized method of reducing insurance costs as in claim 3 further comprising calculating the predetermined maximum dollar value as being equal to a lowest relative price of a set of 5% of all drugs having a highest relative price.

5. The computerized method of reducing insurance costs as in claim 1 wherein the step of determining the price further comprising searching for pharmacies within a predetermined geographic distance from the consumer.

6. The computerized method of reducing insurance costs as in claim 5 further comprising sending an identifier of the drug to any identified pharmacies within the predetermined distance along with a request for a price quotation.

7. The computerized method of reducing insurance costs as in claim 1 further comprising a global positioning system receiver determining a position of the consumer.

8. The computerized method of reducing insurance costs as in claim 1 further comprising the consumer paying a full amount of the co-pay upon receipt of the drug and receiving a rebate at a later date from the insurer.

9. A computerized apparatus for reducing insurance costs for a drug to an insurer and a consumer comprising:
means for determining a price of the drug from a plurality of pharmacies;
means for selecting a pharmacy of the plurality of pharmacies with a lower relative price for purchase of the drug; and
means for determining a co-pay based upon a predetermined percentage of the price of the drug.

10. The computerized apparatus for reducing insurance costs as in claim 9 further comprising means for determining the predetermined percentage by dividing a total drug cost for an insurance plan segment covering the drug by total pharmaceutical expenses for the plan segment.

11. The computerized apparatus for reducing insurance costs as in claim 10 further comprising means for limiting the co-pay to a predetermined maximum dollar value.

12. The computerized apparatus for reducing insurance costs as in claim 11 further comprising means for calculating the predetermined maximum dollar value as being equal to a lowest relative price of a set of 5% of all drugs having a highest relative price.

13. The computerized apparatus for reducing insurance costs as in claim 9 wherein the means for determining the price further comprising means for searching for pharmacies within a predetermined geographic distance from the consumer.

14. The computerized apparatus for reducing insurance costs as in claim 13 further comprising means for sending an identifier of the drug to any identified pharmacies within the predetermined distance along with a request for a price quotation.

15. The computerized apparatus for reducing insurance costs as in claim 9 further comprising a global positioning system receiver determining a position of the consumer.

16. The computerized apparatus for reducing insurance costs as in claim 9 further comprising means for providing a rebate to the consumer at a later date from the insurer where the consumer has paid a full amount for the drug.

17. A computerized apparatus for reducing insurance costs for a drug to an insurer and a consumer comprising:
a search processor that determines a price of the drug from a plurality of pharmacies;
a display of drug pricing information that allows the consumer to select a pharmacy of the plurality of pharmacies with a lower relative price for purchase of the drug; and
a co-pay processor that determines a co-pay based upon a pre-determined percentage of the price of the drug.

18. The computerized apparatus for reducing insurance costs as in claim 17 further comprising a comparator that limits the co-pay to a predetermined maximum dollar value.

19. The computerized apparatus for reducing insurance costs as in claim 17 further comprising a location processor that searches for pharmacies within a predetermined geographic distance from the consumer.

20. The computerized apparatus for reducing insurance costs as in claim 17 further comprising a global positioning system receiver determining a position of the consumer.
